(19) United States
(12) Patent Application Publication
(10) Pub. No.: US 2003/0168936 A1
(43) Pub. Date: Sep. 11, 2003

(54) Electro-active polymer as a fuel vapor control valve actuator

(76) Inventors: Gary M. Everingham, Chatham (CA); Andre Veinotte, Dresden (CA)

Correspondence Address: MORGAN LEWIS & BOCKIUS LLP, 1111 PENNSYLVANIA AVENUE NW, WASHINGTON, DC, 20004, US

(21) Appl. No.: 10/290,482

(22) Filed: Nov. 8, 2002

Related U.S. Application Data
(60) Provisional application No. 60/337,808, filed on Nov. 8, 2001.

(51) Int. Cl. H02N 2/00

(52) U.S. Cl. 310/328

(57) ABSTRACT

An apparatus, system, and method using a canister purge valve including an electro-active polymer actuator. Such a canister purge valve can be used in a system and method for supplying fuel to an internal combustion engine, which includes an intake manifold. The fuel system includes a fuel tank that has a headspace, a fuel vapor collection canister that is in fluid communication with the headspace, and a canister purge valve that is in fluid communication between the fuel vapor collection canister and the intake manifold. The canister purge valve includes a body and a member. The body has a first port that is in fluid communication with the fuel vapor collection canister, and a second port that is in fluid communication with the intake manifold. The member is arrangeable between first and second configurations. The first configuration prohibits fuel vapor flow from the fuel vapor collection canister to the intake manifold, and the second configuration permits fuel vapor flow from the fuel vapor collection canister to the intake manifold. And the member includes an electro-active polymer that dimensionally reacts to an electric field.

### CROSS REFERENCE TO CO-PENDING APPLICATIONS

This application claims the benefit of the earlier filing date of U.S. Provisional Application No. 60/337,808, filed Nov. 8, 2001, the disclosure of which is incorporated by reference herein in its entirety.

### FIELD OF THE INVENTION

This invention relates generally to on-board emission control systems for internal combustion engine powered motor vehicles, e.g., evaporative emission control systems, and more particularly to an emission control valve, such as a canister purge valve for an evaporative emission control system.

This invention also relates to an apparatus and a method of actuating an emission control valve, which includes an electro-active polymer (EAP) actuator.

### BACKGROUND OF THE INVENTION

It is believed that known on-board evaporative emission control systems include a vapor collection canister that collects fuel vapor emanating from a tank that contains volatile liquid fuel for an internal combustion engine, and a canister purge valve for periodically purging collected vapor to an intake manifold of the engine.

A first know canister purge valve is actuated via a diaphragm in response to a vacuum signal, such as from the intake manifold of the engine. A second known canister purge valve is actuated via an electromagnetic solenoid that is under the control of a purge control signal, which can be generated by a microprocessor-based engine management system.

These known canister purge valves are believed to typically include a number of discrete components, which must be assembled. It is believed that the costs of the components and their assembly can be a disadvantage. Thus, it is believed that there is a need to provide a canister purge valve that provides the same types of functions, but which costs less and provides improved performance relative to known canister purge valves.

### SUMMARY OF THE INVENTION

The present invention provides a system for supplying fuel to an internal combustion engine, which includes an intake manifold. The fuel system includes a fuel tank that has a headspace, a fuel vapor collection canister that is in fluid communication with the headspace, and a canister purge valve that is in fluid communication between the fuel vapor collection canister and the intake manifold. The canister purge valve includes a body and a member. The body has a first port that is in fluid communication with the fuel vapor collection canister, and a second port that is in fluid communication with the intake manifold. The member is arrangeable between first and second configurations. The first configuration prohibits fuel vapor flow from the fuel vapor collection canister to the intake manifold, and the second configuration permits fuel vapor flow from the fuel vapor collection canister to the intake manifold. And the member includes an electro-active polymer that dimensionally reacts to an electric field.

The present invention also provides a canister purge valve assembly for regulating a fuel vapor flow. The valve assembly includes a body that has a passage, which extends between a first port and a second port, and a member arrangeable between a first configuration that prohibits the fuel vapor flow through the passage and a second configuration that permits the fuel vapor flow through the passage. The member includes an electro-active polymer that dimensionally reacts to an electric field.

The present invention also provides a method of controlling evaporative emissions of a volatile fuel from a fuel system for an internal combustion engine including an intake manifold. The fuel system includes a fuel tank that stores the volatile fuel and has a headspace, and a fuel vapor collection canister that is in fluid communication with the headspace. The method includes regulating with a valve a flow of fuel vapor from the fuel vapor collection canister to the intake manifold. The valve includes an electro-active polymer that dimensionally reacts to an electrical field. In a first configuration of the electro-active polymer, the flow of fuel vapor is prohibited, and in a second configuration of the electro-active polymer, the flow of fuel vapor is permitted. The method also includes controlling the electrical field with an engine control unit.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a schematic illustration of an evaporative emission control system including a canister purge valve.

FIG. 2 is a schematic illustration of a canister purge valve according to a first preferred embodiment.

FIG. 3 is a schematic illustration of a canister purge valve according to a second preferred embodiment.

FIG. 4 is a schematic illustration of a canister purge valve according to a third preferred embodiment.

FIG. 5 is a schematic illustration of a canister purge valve according to a fourth preferred embodiment.

FIG. 6A is a block diagram of a power supply driving a canister purge valve with a proportional electrical signal.

FIG. 6B is a block diagram of a power supply driving a canister purge valve with a digital electrical signal.

### DETAILED DESCRIPTION OF THE PREFERRED EMBODIMENTS

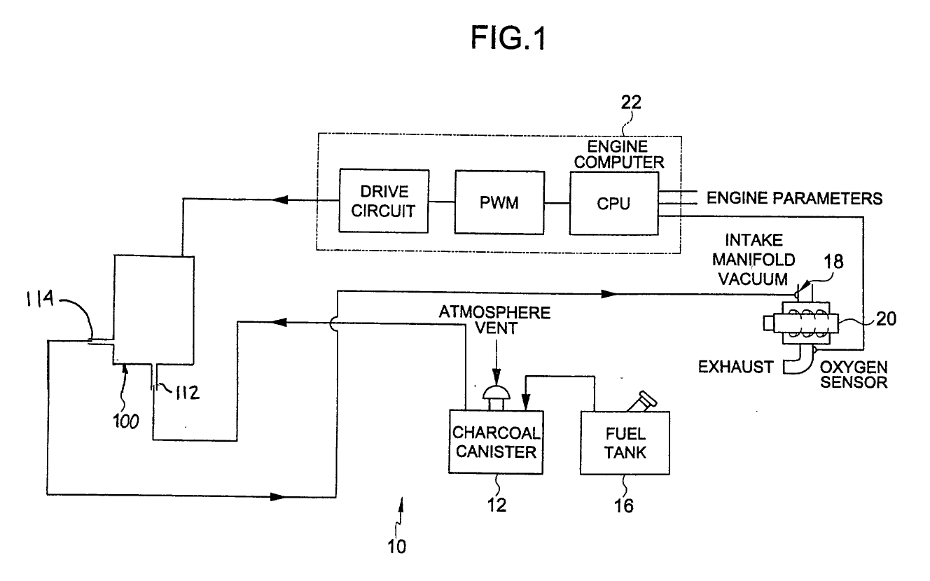

FIG. 1 shows an evaporative emission control system 10, such as for a motor vehicle (not shown), that includes a vapor collection canister 12, and a canister purge valve 100 according to the preferred embodiments. The vapor collection canister 12 and the canister purge valve 100 are connected in series between a fuel tank 16 and an intake manifold 18 of an internal combustion engine 20. A computer, preferably an engine control unit 22, receives various input signals and supplies a purge control output signal for the operating canister purge valve 100.

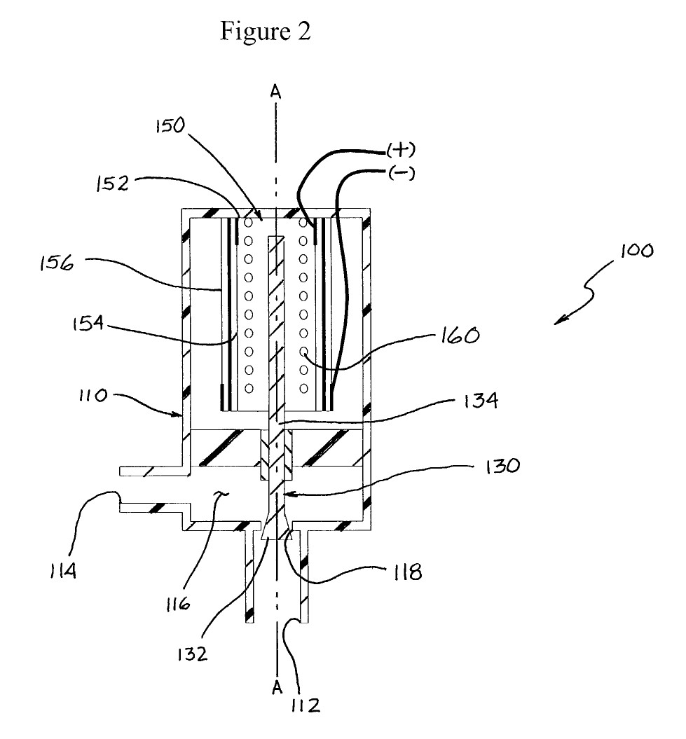

Referring to FIG. 2, the canister purge valve 100 includes a body part 110 having an inlet port 112 and an outlet port 114. Body part 110 is fabricated from suitable fuel-tolerant material, such as an injection-molded plastic, and embodies the two ports as respective nipples. Body part 110 can include a formation (not shown) that provides for the mounting of the canister purge valve 100 at a suitable mounting location on an automotive vehicle, e.g., on the vapor collection canister 12. The body part 110 defines a passage 116 that extends between the inlet and outlet ports 112, 114. A seat 118, which may be formed by the body part 110, can define a portion of the passage 116.

Canister purge valve 100 further includes a pintle 130 and an actuator 150. The pintle 130 includes a head 132 and a stem 134, which is operably coupled to the actuator 150. The pintle 130, and the stem 134 in particular, may be integrated with the actuator 150. The pintle 130 is displaceable along a longitudinal axis A-A between first and second configurations of the canister purge valve 100. In the first configuration of the canister purge valve 100, fuel vapor flow through the passage 116 is prohibited by virtue of the head 132 sealingly engaging the seat 118. In a second configuration of the canister purge valve 100, fuel vapor flow through the passage 116 is permitted by virtue of the head 132 being spaced from the seat 118. Preferably, the stem 134 is supported for reciprocal movement along the longitudinal axis A-A by a bearing mounted with respect to the body part 110.

The actuator 150 preferably includes an electro-active polymer (EAP) that converts electrical energy to mechanical energy. In particular, in response to a change in an electric field, the EAP will dimensionally react. As it is used in this application, the phrase “dimensionally react” refers to any displacement, expansion, contraction, torsion, linear or area strain, or any other deformation of a portion of the EAP. The form of the dimensional reaction can be selected in accordance with the geometry, i.e., shape, of the EAP, the arrangement of electrodes creating the electric field, and the constraints, e.g., connecting fixtures, acting on the EAP.

As it is used in this application, an EAP is any substantially insulating polymer, dielectric elastomer polymer, silicone rubbers, fluoroelastomers, silicones, acrylic polymers, or rubber that deforms in response to an electrostatic force or whose deformation results in a change in an electric field. Examples of suitable EAP materials include NuSil CF19-2186, which is available from NuSil Technology of Carpenteria, Calif.; Dow Corning HS3 and Dow Corning 730, which are available from Dow Corning of Wilmington, Del.; and the 4900 VHB acrylic series, which are available from 3M Corporation of St. Paul, Minn.

Preferably, an EAP according to the present invention is pre-strained to improve conversion between electrical and mechanical energy. Pre-straining can improve the dielectric strength of the polymer, and can allow the EAP to dimensionally react more and provide greater mechanical work. The pre-straining can include elastic deformation of the polymer, which may be implemented by stretching the polymer in tension, or by fixing one or more edges while the polymer is being stretched.

According to the first preferred embodiment illustrated in FIG. 1, the actuator 150 includes an EAP that expands in a plane direction in response to the application of an electric field. The EAP is constrained by virtue of having a surface 152 fixed to the body part 110. Preferably, the EAP has an annular shape with a first electrode 154 that is located interiorly, i.e., on a radially inner surface, with respect to the EAP, and a second electrode 156 that is located exteriorly, i.e., on a radially outer surface, with respect to the EAP.

Preferably, a resilient element 160 pre-strains the EAP. Specifically, the resilient element 160, e.g., a coil spring, elastically deforms, e.g., stretches, the EAP.

In operation, a voltage potential is applied across the first and second electrodes 154, 156, e.g., the first electrode 154 can be connected to a positive pole of a voltage source and the second electrode 156 can be connected to a negative pole of a voltage source. As discussed with respect to FIG. 1, the engine control unit 22 supplies to the canister purge valve 100 the purge control signal that controls the electrical field created between the first and second electrodes 154, 156.

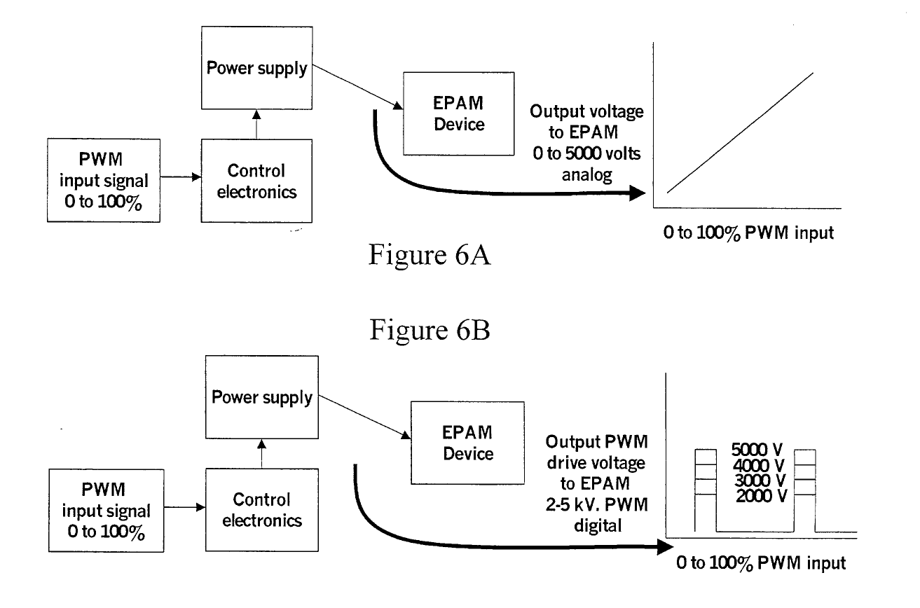

Referring also to FIG. 6A, the engine control unit 22 can include a pulse width modulator and a drive circuit that supplies a proportional electrical purge control signal. According to a first preferred example, the drive circuit applies across the first and second electrodes 154, 156 an analog output signal having a voltage between zero and 5000 volts, which corresponds to a pulse width modulated input signal from zero to 100 percent.

Referring alternatively to FIG. 6B, according to a second preferred example, the drive circuit applies across the first and second electrodes 154, 156 an output pulse width modulated digital signal having amplitude between 2000 and 5000 volts, which corresponds to a pulse width modulated input signal from zero to 100 percent. Thus, the purge control signal is a duty-cycle modulated square-pulse waveform having a relatively low operating frequency that is governed by the natural frequency of the EAP, e.g., in the ˜0 Hertz to 40 Hertz range, which is modulated over a range from zero to 100 percent. This means that for each cycle of the operating frequency, the first and second electrodes 154, 156 create an electric field for a certain percentage of the time period of the cycle. As this percentage increases, the time during which the EAP dimensionally reacts also increases, and therefore so does the purge flow through the valve. Conversely, the purge flow decreases as the percentage decreases.

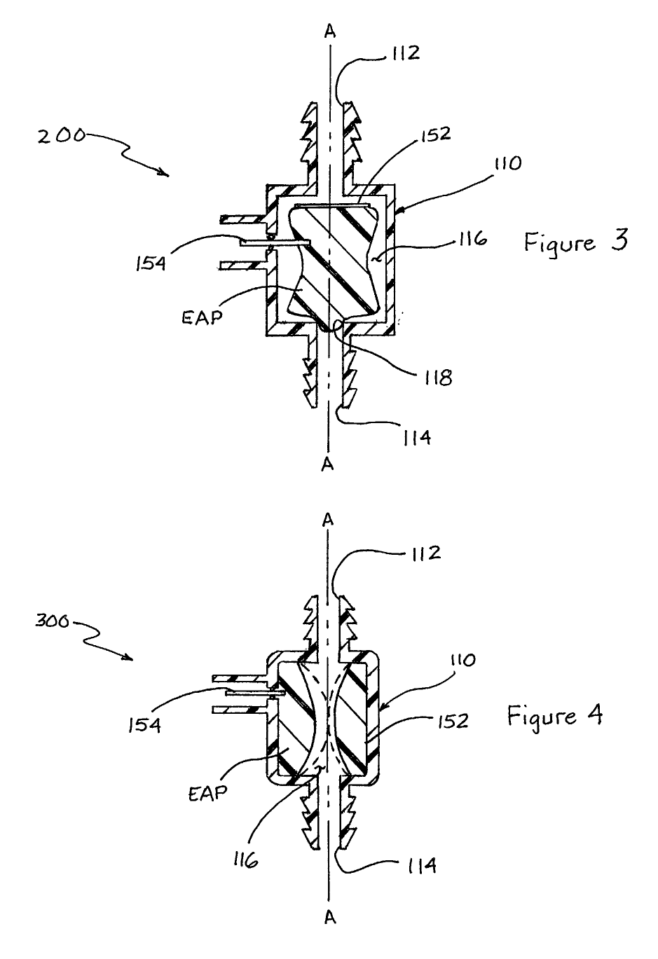

FIG. 3 shows a second preferred embodiment of a canister purge valve 200 that differs in at least four aspects from the canister purge valve 100 of FIG. 2. First, the inlet port 112 and the outlet port 114 extend from opposite ends of the body part 110 so as to form a so-called “flow-through” design. Second, the EAP per se contiguously contacts the seat 118 in the first configuration of the canister purge valve 200. Third, in the second configuration of the canister purge valve 200, the EAP contracts in the presence of an electric field. And fourth, the EAP is exposed to the flow of fuel vapor through the canister purge valve 200 in the second configuration. The canister purge valve 200 is also similar to the canister purge valve 100 of FIG. 2 at least in that both embodiments rely on a linear dimensional reaction of the EAP.

FIG. 4 shows a third preferred embodiment of a canister purge valve 300 that differs from the first and second embodiments (FIGS. 2 and 3, respectively) at least in that the EAP dimensionally reacts radially rather than linearly. In particular, the EAP has an annular shape providing an aperture through which fuel vapor flows in the second configuration of the canister purge valve 300. In the first configuration of the canister purge valve 300, the aperture through the EAP is so constricted as to prohibit the flow of fuel vapor. Preferably, the EAP contracts in the presences of an electric field so as to assume the second configuration of the canister purge valve 300.

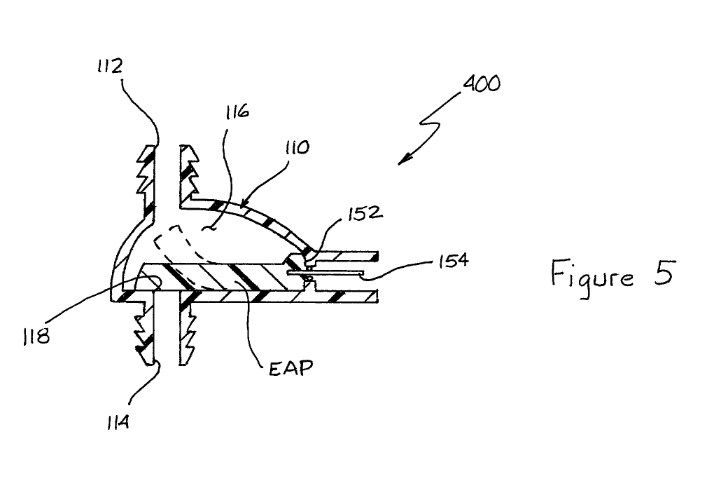

FIG. 5 shows a fourth preferred embodiment of a canister purge valve 400 that differs from the first, second, and third embodiments (FIGS. 2-4, respectively) at least in that the EAP includes a beam that is deflected, e.g., is caused to bend or curl, in the second configuration of the canister purge valve 400. As such, the deflection spaces the EAP from the seat 118 so as to permit fuel vapor flow through the canister purge valve 400.

Thus, according to the preferred embodiments, EAP can be used to provide a linear motive method (e.g., canister purge valves 100 and 200), a radial motive method (e.g., canister purge valve 300), and a bending motive method (e.g., canister purge valve 400).

According to the preferred embodiments, EAP technology is used to actuate a fuel vapor flow control valve. This is in contrast to known fuel vapor flow control systems that utilize vacuum/diaphragm arrangements or electromagnetic actuators. Consequently, the preferred embodiments overcome several disadvantages of these known systems, including the cost of providing and assembling an increased number of discrete components. For example, the preferred embodiments have a lower cost since EAP is fabricated from materials such as silicone rubber, which is substantially less expensive than copper based electromagnetic solenoids. Further, the preferred embodiments are able to provide higher performance than these known systems. Because EAP is able to react much faster than an electromagnetic solenoid, the preferred embodiments are able to provide better control of the fuel vapor flow.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. A system for supplying fuel to an internal combustion engine including an intake manifold, the fuel system comprising:
a fuel tank having a headspace;
a fuel vapor collection canister in fluid communication with the headspace; and
a canister purge valve in fluid communication between the fuel vapor collection canister and the intake manifold, the canister purge valve including:
a body having a first port in fluid communication with the fuel vapor collection canister and a second port in fluid communication with the intake manifold; and
a member arrangeable between first and second configurations, the first configuration prohibiting fuel vapor flow from the fuel vapor collection canister to the intake manifold, and the second configuration permitting fuel vapor flow from the fuel vapor collection canister to the intake manifold, and the member including an electro-active polymer that dimensionally reacts to an electric field.

2. The fuel system according to claim 1, comprising:
an engine control unit operatively connected to the canister purge valve.

3. The fuel system according to claim 2, the member comprising at least one electrode proximate to the electro-active polymer and at least one terminal passing through the body, the at least one electrode is adapted to emit the electric field and the at least one terminal is adapted to connect the electrode to the engine control unit.

4. A canister purge valve assembly for regulating a fuel vapor flow, the valve assembly comprising:
a body having a passage extending between a first port and a second port; and
a member arrangeable between a first configuration prohibiting the fuel vapor flow through the passage and a second configuration permitting the fuel vapor flow through the passage, the member including an electro-active polymer that dimensionally reacts to an electric field.

5. The canister purge valve assembly according to claim 4, wherein the electro-active polymer expands in the presence of the electric field and contracts in the absence of the electric field.

6. The canister purge valve assembly according to claim 5, comprising:
a seat defining a portion of the passage.

7. The canister purge valve assembly according to claim 6, wherein the member comprises a head coupled to the electro-active polymer, the head contiguously engages the seat and occludes the passage in the first configuration and is spaced from the seat in the second configuration.

8. The canister purge valve assembly according to claim 6, wherein the electro-active polymer comprises a head, the head contiguously engages the seat and occludes the passage in the first configuration and is spaced from the seat in the second configuration.

9. The canister purge valve assembly according to claim 6, wherein the electro-active polymer contiguously engages the seat and occludes the passage in the first configuration and is spaced from the seat in the second configuration.

10. The canister purge valve assembly according to claim 6, wherein the body comprises the seat.

11. The canister purge valve assembly according to claim 5, wherein the electro-active polymer in the absence of the electric field comprises an annular shape cincturing the passage, and the electro-active polymer in the presence of the electric field expands radially inward so as to occlude the passage.

12. The canister purge valve assembly according to claim 4, wherein the electro-active polymer comprises a nominal position in the absence of the electric field and deflects from the nominal position in the presence of the electric field.

13. The canister purge valve assembly according to claim 12, comprising:
a seat defining a portion of the passage.

14. The canister purge valve assembly according to claim 13, wherein the electro-active polymer in the nominal position comprises a beam contiguously engaging the seat and occluding the passage in the first configuration, and the beam deflects from the seat in the second configuration.

15. The canister purge valve assembly according to claim 4, wherein the body comprises molded plastic.

16. The canister purge valve assembly according to claim 4, wherein a portion of the electro-active polymer is constrained against movement by a portion of the body.

17. The canister purge valve assembly according to claim 4, comprising:
at least one electrode located proximate to the electro-active polymer and adapted to emit the electric field; and
at least one terminal passing through the body and adapted to connect the at least one electrode to a source of electricity.

18. The canister purge valve assembly according to claim 4, comprising:
an elastic member straining the electro-active polymer.

19. A method of controlling evaporative emissions of a volatile fuel from a fuel system for an internal combustion engine including an intake manifold, the fuel system including a fuel tank storing the volatile fuel and having a headspace, a fuel vapor collection canister in fluid communication with the headspace, the method comprising:
regulating with a valve a flow of fuel vapor from the fuel vapor collection canister to the intake manifold, the valve including an electro-active polymer that dimensionally reacts to an electrical field, in a first configuration of the electro-active polymer the flow of fuel vapor is prohibited and in a second configuration of the electro-active polymer the flow of fuel vapor is permitted; and
controlling the electrical field with an engine control unit.

20. The method according to claim 19, wherein the controlling comprises supplying a proportional electrical signal that creates the electrical field.

21. The method according to claim 19, wherein the controlling comprises supplying a digital electrical signal that creates the electrical field.
